(19) United States
(12) Patent Application Publication
(10) Pub. No.: US 2026/0226271 A1
(43) Pub. Date: Aug. 6, 2026

(54) Biodegradable Polymer Blend

(71) Applicant: Kimberly-Clark Worldwide, Inc., Neenah, WI (US)

(72) Inventors: Bryan D. Haynes, Jasper, GA (US); Bryon P. Day, Acworth, GA (US); Andrew J. Guest, Sandy Springs, GA (US)

(21) Appl. No.: 19/149,367

(22) PCT Filed: Jan. 23, 2024
(86) PCT No.: PCT/US2024/012516

§ 371 Date: Jul. 18, 2025

Related U.S. Application Data
(60) Provisional application No. 63/481,218, filed on Jan. 24, 2023.

(51) Int. Cl. C08L 67/04; C08K 3/34; C08K 5/098; D01F 1/10; D01F 6/62; D01F 8/14; D04H 1/435; D04H 1/4382

(52) U.S. Cl. CPC C08L 67/04; C08K 3/346; C08K 5/098; D01F 1/10; D01F 6/625; D01F 8/14; D04H 1/435; D04H 1/43828; C08L 2201/06; C08L 2203/12; C08L 2205/025; D10B 2331/041; D10B 2401/12

(57) ABSTRACT

A polymer composition is disclosed containing at least one biodegradable polymer combined with minor amounts of a non-biodegradable polymer for providing strength and improved processing. At least one prodegradant is included in the polymer composition for accelerating the degradation rate of the non-biodegradable polymer. The polymer composition is particularly well suited to producing fibers and films.

### BACKGROUND

Various attempts have been made to form nonwoven webs from biodegradable polymers. Although fibers prepared from biodegradable polymers are known, problems have been encountered with their use. For example, polylactic acid (“PLA”) is one of the most common biodegradable and sustainable (renewable) polymers used to form nonwoven webs. Unfortunately, PLA nonwoven webs generally possess a low bond flexibility and high roughness due to the high glass transition temperature and slow crystallization rate of polylactic acid. In turn, thermally bonded PLA nonwoven webs often exhibit low elongations that are not acceptable in certain applications, such as in an absorbent article. Likewise, though polylactic acid may withstand high draw ratios, it requires high levels of draw energy to achieve the crystallization needed to overcome heat shrinkage.

In addition to PLA, polymer fibers and other components have also been formed from polyhydroxyalkanoate (“PHA”) polymers. PHA polymers, however, have many of the same drawbacks as PLA. In addition, PHA molded articles have a tendency to lack strength for many process and end use applications.

In order to improve strength and processing, biodegradable polymers have been combined with other polymers, such as polyolefins. Incorporating polyolefin polymers into the polymer blend, however, adversely affects the biodegradable properties of the resulting product. For instance, the biodegradable polymer can quickly break down and decompose after use possibly leaving microplastics formed from the polyolefin.

In view of the above, a need exists for polymer blends containing biodegradable polymers that have enhanced biodegradation rates. A need also exists for a polymer blend well suited to producing fibers and films that is biodegradable and possesses good mechanical strength and processing properties.

### SUMMARY

In general, the present disclosure is directed to polymer blends containing at least one biodegradable polymer, such as a biodegradable polyester polymer in combination with small amounts of a non-biodegradable polymer, such as a polyester polymer or a polyolefin polymer that provides enhanced strength or improved processing. In one aspect, the biodegradable polymer forms a polymer matrix and the non-biodegradable polymer forms discrete domains dispersed within the continuous phase of the polymer matrix. In accordance with the present disclosure, the polymer blend further contains an additive that promotes degradation of the non-biodegradable polymer.

For example, in one embodiment, the present disclosure is directed to a polymer composition containing a biodegradable polyester polymer present in the polymer composition in an amount greater than about 40% by weight, such as in an amount greater than about 50% by weight, such as in an amount greater than about 60% by weight, such as in an amount greater than about 70% by weight. The polymer composition further contains a polymeric strength enhancing agent. The polymeric strength enhancing agent can comprise a polyolefin, a polyalkylene terephthalate, or mixtures thereof. The polymeric strength enhancing agent can be present in relatively minor amounts. For instance, the polymeric strength enhancing agent can be present in the polymer composition in an amount less than about 25% by weight, such as in an amount less than about 15% by weight, such as in an amount less than about 10% by weight, such as in an amount less than about 8% by weight, such as in an amount less than about 5% by weight. One or more polymeric strength enhancing agents are generally present in the polymer composition in an amount greater than about 0.25% by weight, such as in amounts greater than about 0.5% by weight. The polymer composition of the present disclosure further contains at least one prodegradant. The at least one prodegradant accelerates a degradation rate of the polymeric strength enhancing agent.

Various different prodegradants can be incorporated into the polymer composition. In one aspect, the at least one prodegradant comprises a transition metal compound. The transition metal compound can comprise an iron, a manganese, or a copper saft, such as a saft of a carboxylic acid. In one particular embodiment, the transition metal compound comprises an iron stearate, a manganese stearate, a copper stearate, or mixtures thereof. One or more transition metal compounds can be present in the polymer composition generally in an amount from about 0.08% by weight to about 0.5% by weight.

The prodegradant can also comprise an unsaturated carboxylic acid having a carbon chain length of from about 12 carbon atoms to about 26 carbon atoms or can comprise an ester, an anhydride, or an amide of the carboxylic acid. The unsaturated carboxylic acid or ester, anhydride, or amide thereof can be present in the polymer composition in an amount from about 0.01% by weight to about 0.2% by weight and can be present alone or in combination with one or more transition metal compounds.

Other prodegradants that can be present in the polymer composition include a sugar such as starch, a calcium oxide, a calcium carbonate, or mixtures thereof. Still other prodegradants can include a furanone compound, a glutaric acid, a hexadecenoic acid compound, or mixtures thereof.

In one aspect, the strength enhancing agent comprises a polyolefin. The polyolefin can be a propylene homopolymer, a propylene/alpha olefin copolymer, or a combination thereof. The polyolefin can also be an ethylene homopolymer, an ethylene copolymer, an ethylene/alpha olefin copolymer, or combinations thereof. In still another aspect, the polymeric strength enhancing agent can comprise a polyalkylene terephthalate. The polyalkylene terephthalate can comprise a polyethylene terephthalate.

Various different biodegradable polyester polymers can be incorporated into the polymer composition. In one embodiment, the biodegradable polyester polymer comprises a polyhydroxyalkanoate. For instance, in one aspect, the biodegradable polymer can comprise a polyhydroxybutyrate.

In an alternative embodiment, the biodegradable polymer can comprise a polylactic acid. The polylactic acid, for instance, can be present in combination with a polyhydroxyalkanoate.

The polymer composition can also contain various other additives. For instance, in one embodiment, the polymer composition can also contain a filler. The filer, for instance, can comprise clay particles, such as diatomaceous earth. The filler particles can be present in the polymer composition in an amount less than about 5% by weight, such as in an amount less than about 4% by weight, such as in an amount less than about 3% by weight.

The present disclosure is also directed to fibers formed from the polymer composition. The fibers can be made in any suitable manner and can comprise continuous fibers or discontinuous fibers including staple fibers. In one aspect, the fiber can comprise a meltblown fiber or a spunbond fiber. The fiber can be a monocomponent fiber made entirely from the polymer composition or can comprise a multicomponent fiber, such as a bicomponent fiber. In one aspect, for instance, the bicomponent fiber can include a sheath polymer surrounding a core polymer. The core polymer can be made from the polymer composition of the present disclosure. The sheath polymer, on the other hand, can be made entirely from one or more biodegradable polymers. For example, the sheath polymer can be made from a polyhydroxyalkanoate, a polylactic acid, or mixtures thereof.

In still another aspect, the present disclosure is directed to a nonwoven web comprising a plurality of fibers formed in accordance with the present disclosure. The nonwoven web, for instance, can be a spunbond web or a meltblown web.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a schematic illustration of a process that may be used in one embodiment of the present disclosure to form fibers; and

FIG. 2 is one embodiment of a fiber that may be made in accordance with the present disclosure.

Repeat use of reference characters in the present specification and drawings is intended to represent the same or analogous features or elements of the present invention.

### Definitions

As used herein, the term “biodegradable” or “biodegradable polymer” generally refers to a material that degrades from the action of naturally occurring microorganisms, such as bacteria, fungi, and algae; environmental heat; moisture; or other environmental factors. The biodegradability of a material may be determined using ASTM Test Method 5338.92.

As used herein, the term “fibers” refer to elongated extrudates formed by passing a polymer through a forming orifice such as a die. Unless noted otherwise, the term “fibers” includes both discontinuous fibers having a definite length and substantially continuous filaments. Substantially filaments may, for instance, have a length much greater than their diameter, such as a length to diameter ratio (“aspect ratio”) greater than about 15,000 to 1, and in some cases, greater than about 50,000 to 1.

As used herein, the term “monocomponent” refers to fibers formed from one polymer. Of course, this does not exclude fibers to which additives have been added for color, anti-static properties, lubrication, hydrophilicity, liquid repellency, etc.

As used herein, the term “multicomponent” refers to fibers formed from at least two polymers (e.g., bicomponent fibers) that are extruded from separate extruders. The polymers are arranged in substantially constantly positioned distinct zones across the cross-section of the fibers. The components may be arranged in any desired configuration, such as sheath-core, side-by-side, segmented pie, island-in-the-sea, and so forth. Various methods for forming multicomponent fibers are described in U.S. Pat. No. 4,789,592 to Taniguchi et al. and U.S. Pat. No. 5,336,552 to Strack et al., U.S. Pat. No. 5,108,820 to Kaneko, et al., U.S. Pat. No. 4,795,668 to Kruege, et al., U.S. Pat. No. 5,382,400 to Pike, et al, U.S. Pat. No. 5,336,552 to Strack, et al., and U.S. Pat. No. 6,200,669 to Marmon, et al., which are incorporated herein in their entirety by reference thereto for all purposes. Multicomponent fibers having various irregular shapes may also be formed, such as described in U.S. Pat. No. 5,277,976 to Hogle, at al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

As used herein, the term “nonwoven web” refers to a web having a structure of individual fibers that are randomly interlaid, not in an identifiable manner as in a knitted fabric. Nonwoven webs include, for example, meltblown webs, spunbond webs, carded webs, wet-laid webs, airlaid webs, coform webs, hydraulically entangled webs, etc. The basis weight of the nonwoven web may generally vary, but is typically from about 5 grams per square meter (“gsm”) to 200 gsm, in some embodiments from about 10 gsm to about 150 gsm, and in some embodiments, from about 15 gsm to about 100 gsm.

As used herein, the term “meltblown” web or layer generally refers to a nonwoven web that is formed by a process in which a molten thermoplastic material is extruded through a plurality of fine, usually circular, die capillaries as molten fibers into converging high velocity gas (e.g., air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al.; U.S. Pat. No. 4,307,143 to Meitner, et al.; and U.S. Pat. No. 4,707,398 to Wisneski, et al., which are incorporated herein in their entirety by reference thereto for all purposes. Meltblown fibers may be substantially continuous or discontinuous, and are generally tacky when deposited onto a collecting surface.

As used herein, the term “spunbond” web or layer generally refers to a nonwoven web containing small diameter substantially continuous filaments. The filaments are formed by extruding a molten thermoplastic material from a plurality of fine, usually circular, capillaries of a spinnerette with the diameter of the extruded filaments then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes.

Spunbond filaments are generally not tacky when they are deposited onto a collecting surface Spunbond filaments may sometimes have diameters less than about 40 micrometers, and are often between about 5 to about 20 micrometers.

The Tensile Properties of fibers can be measured according the following procedure. Individual fiber specimens are shortened (e.g., cut with scissors) to 38 millimeters in length, and placed separately on a black velvet cloth. 10 to 15 fiber specimens are collected in this manner. The fiber specimens are then mounted in a substantially straight condition on a rectangular paper frame having external dimension of 51 millimeters×5l millimeters and internal dimension of 25 millimeters×25 millimeters. The ends of each fiber specimen are operatively attached to the frame by carefully securing the fiber ends to the sides of the frame with adhesive tape. Each fiber specimen is then measured for its external, relatively shorter, cross-fiber dimension employing a conventional laboratory microscope, which has been properly calibrated and set at 40× magnification. This cross-fiber dimension is recorded as the diameter of the individual fiber specimen. The frame helps to mount the ends of the sample fiber specimens in the upper and lower grips of a constant rate of extension type tensile tester in a manner that avoids excessive damage to the fiber specimens.

A constant rate of extension type of tensile tester and an appropriate load cell are employed for the testing. The load cell is chosen (e.g., 10N) so that the test value falls within 10-90% of the full scale load. The tensile tester (i.e., MTS SYNERGY 200) and load cell are obtained from MTS Systems Corporation of Eden Prairie, Mich. The fiber specimens in the frame assembly are then mounted between the grips of the tensile tester such that the ends of the fibers are operatively held by the grips of the tensile tester. Then, the sides of the paper frame that extend parallel to the fiber length are cut or otherwise separated so that the tensile tester applies the test force only to the fibers. The fibers are then subjected to a pull test at a pull rate and grip speed of 12 inches per minute. The resulting data is analyzed using a TESTWORKS 4 software program from the MTS Corporation with the following test settings.

| Calculation Inputs | | | Test Inputs | | |
|---|---|---|---|---|---|
| Break mark drop | 50% | | Break sensitivity | 90% | |
| Break marker | 0.1 | in | Break threshold | 10 | g_{f} |
| elongation | | | | | |
| Nominal gage length | 1 | in | Data Acq. Rate | 10 | Hz |
| Slack pre-load | 1 | lb_{f} | Denier length | 9000 | m |

| | | | | |
|---|---|---|---|---|
| Slope segment length | 20% | Density | 1.25 | g/cm³ |
| Yield offset | 0.20% | Initial speed | 12 | in/min |
| Yield segment length | 2% | Secondary speed | 2 | in/min |

The tenacity values are expressed in terms of gram-force per denier. Peak elongation (% strain at break) is also measured.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer blend that is not only easy to process and has excellent physical properties, but also has excellent biodegradation properties. The primary component of the polymer blend is one or more biodegradable polymers. The biodegradable polymer, for instance, can comprise at least one polyhydroxyalkanoate. Alternatively, the polymer blend may contain a polylactic acid alone or in combination with one or more polyhydroxyalkanoates. The at least one biodegradable polymer is combined with a polymeric strength enhancing agent. The polymeric strength enhancing agent can comprise a non-biodegradable polymer that is capable of enhancing the strength characteristics of the at least one biodegradable polymer and/or improve processing of the polymer that can result in improved mechanical properties. The polymeric strength enhancing agent, for instance, can comprise a polyolefin or a polyester, such as polyethylene terephthalate. The polymeric strength enhancing agent, for instance, can provide a performance boost to one or more mechanical properties of the biodegradable polymer which can occur due to the rapid crystallization of the polymeric strength enhancing agent optionally coupled with the backbone of the polymer chain that enhances strength. Of particular advantage, it was discovered that only small amounts of the polymeric strength enhancing agent need be included in the polymer composition in order to receive dramatically improved results. For example, the polymeric strength enhancing agent can double or even triple the tensile strength of articles formed from the polymer blend (e.g. of fibers).

In accordance with the present disclosure, the polymer composition further contains at least one prodegradant that accelerates a degradation rate of the polymeric strength enhancing agent. The prodegradant, for instance, significantly increases the biodegradation rate of the polymeric strength enhancing agent in a manner that deters the formation of microplastics when polymer compositions formed from the polymer blend are disposed of and are degraded. The prodegradant, for instance, can act as an initiator so that domains comprised of the polymeric strength enhancing agent contained within the polymer composition biodegrade at a rate that is comparable to the biodegradable polymer contained in the blend.

As described above, the polymer composition contains at least one biodegradable polymer. The biodegradable polymer, in one aspect, can be a biodegradable polyester polymer, such as an aliphatic or aromatic polyester. The biodegradable polyester polymer can be one or more polyhydroxyalkanoates (PHA), such as poly-3-hydroxybutyrate (PHB), poly-3-hydroxyvalerate (PHV), poly-3-hydroxybutyrate-co-4-hydroybutyrate, poly-3-hydroxybutyrate-co-3-hydroxyvalerate copolymers (PHBV), poly-3-hydroxybutyrate-co-3-hydroxyhexanoate, poly-3-hydroxybutyrate-co-3-hydroxyoctanoate, poly-3-hydroxybutyrate-co-3-hydroxydecanoate, poly-3-hydroxybutyrate-co-3-hydroxyoctadecanoate, and mixtures thereof.

Other examples of suitable biodegradable aliphatic polyesters include polycaprolactone, polyesteramides, modified polyethylene terephthalate, polylactic acid (PLA) and its copolymers, terpolymers based on polylactic acid, polyglycolic acid, polyalkylene carbonates (such as polyethylene carbonate), and succinate-based aliphatic polymers (e.g., polybutylene succinate, polybutylene succinate adipate, polyethylene succinate, etc.).

The biodegradable polymer can also include aromatic polyesters and modified aromatic polyesters, and aliphatic-aromatic copolyesters. In one particular embodiment, the biodegradable polyester is an aliphatic-aromatic copolyester (e.g., block, random, graft, etc.). The aliphatic-aromatic copolyester may be synthesized using any known technique, such as through the condensation polymerization of a polyol in conjunction with aliphatic and aromatic dicarboxylic acids or anhydrides thereof. The polyols may be substituted or unsubstituted, linear or branched, polyols selected from polyols containing 2 to about 12 carbon atoms and polyalkylene ether glycols containing 2 to 8 carbon atoms. Examples of polyols that may be used include, but are not limited to, ethylene glycol, diethylene glycol, propylene glycol, 1,2-propanediol, 1,3-propanediol, 2,2-dimethyl-1,3-propanediol, 1,2-butanediol, 1,3-butanediol, 1,4-butanediol, 1,2-pentanediol, 1,5-pentanediol, 1,6-hexanediol, polyethylene glycol, diethylene glycol, 2,2,4-trimethyl-1,6-hexanediol, thiodiethanol, 1,3-cyclohexanedimethanol, 1,4-cyclohexanedimethanol, 2,2,4,4-tetramethyl-1,3-cyclobutanediol, cyclopentanediol, triethylene glycol, and tetraethylene glycol. Preferred polyols include 1,4-butanediol; 1,3-propanediol; ethylene glycol; 1,6-hexanediol; diethylene glycol; and 1,4-cyclohexanedimethanol.

Representative aliphatic dicarboxylic acids that may be used include substituted or unsubstituted, linear or branched, non-aromatic dicarboxylic acids selected from aliphatic dicarboxylic acids containing 1 to about 10 carbon atoms, and derivatives thereof. Non-limiting examples of aliphatic dicarboxylic acids include malonic, malic, succinic, oxalic, glutaric, adipic, pimelic, azelaic, sebacic, fumaric, 2,2-dimethyl glutaric, suberic, 1,3-cyclopentanedicarboxylic, 1,4-cyclohexanedicarboxylic, 1,3-cyclohexanedicarboxylic, diglycolic, itaconic, maleic, and 2,5-norbornanedicarboxylic. Representative aromatic dicarboxylic acids that may be used include substituted and unsubstituted, linear or branched, aromatic dicarboxylic acids selected from aromatic dicarboxylic acids containing 1 to about 6 carbon atoms, and derivatives thereof. Non-limiting examples of aromatic dicarboxylic acids include terephthalic acid, dimethyl terephthalate, isophthalic acid, dimethyl isophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′ diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid), dimethyl-4,4′-methylenebis(benzoate), etc., and mixtures thereof.

The polymerization may be catalyzed by a catalyst, such as a titanium-based catalyst (e.g., tetraisopropyltitanate, tetraisopropoxy titanium, dibutoxydiacetoacetoxy titanium, or tetrabutyttitanate). If desired, a diisocyanate chain extender may be reacted with the copolyester to increase its molecular weight. Representative diisocyanates may include toluene 2,4-diisocyanate, toluene 2,6-diisocyanate, 2,4′-diphenylmethane diisocyanate, naphthylene-1,5-diisocyanate, xylylene diisocyanate, hexamethylene diisocyanate (“HMDI”), isophorone diisocyanate and methylenebis(2-isocyanatocyclohexane). Trifunctional isocyanate compounds may also be employed that contain isocyanurate and/or biurea groups with a functionality of not less than three, or to replace the diisocyanate compounds partially by tri- or polyisocyanates. The preferred diisocyanate is hexamethylene diisocyanate. The amount of the chain extender employed is typically from about 0.3 to about 3.5 wt. %, in some embodiments, from about 0.5 to about 2.5 wt. % based on the total weight percent of the polymer.

The copolyesters may either be a linear polymer or a long-chain branched polymer. Long-chain branched polymers are generally prepared by using a low molecular weight branching agent, such as a polyol, polycarboxylic acid, hydroxy acid, and so forth. Representative low molecular weight polyols that may be employed as branching agents include glycerol, trimethylolpropane, trimethylolethane, polyethertriols, 1,2,4-butanetriol, pentaerythritol, 1,2,6-hexanetriol, sorbitol, 1,1,4,4,-tetrakis(hydroxymethyl)cyclohexane, tris(2-hydroxyethyl)isocyanurate, and dipentaerythritol. Representative higher molecular weight polyols (molecular weight of 400 to 3000) that may be used as branching agents include triols derived by condensing alkylene oxides having 2 to 3 carbons, such as ethylene oxide and propylene oxide with polyol initiators. Representative polycarboxylic acids that may be used as branching agents include hemimellitic acid, trimellitic (1,2,4-benzenetricarboxylic) acid and anhydride, trimesic (1,3,5-benzenetricarboxylic) acid, pyromellitic acid and anhydride, benzenetetracarboxylic acid, benzophenone tetracarboxylic acid, 1,1,2,2-ethane-tetracarboxylic acid, 1,1,2-ethanetricarboxylic acid, 1,3,5-pentanetricarboxyic acid, and 1,2,3,4-cyclopentanetetracarboxylic acid. Representative hydroxy acids that may be used as branching agents include malic acid, citric acid, tartaric acid, 3-hydroxyglutaric acid, mucic acid, trihydroxyglutaric acid, 4-carboxyphthalic anhydride, hydroxyisophthalic acid, and 4-(beta-hydroxyethyl)phthalic acid. Such hydroxy acids contain a combination of 3 or more hydroxyl and carboxyl groups. Especially preferred branching agents include trimelitic acid, trimesic acid, pentaerythritol, trimethylol propane and 1,2,4-butanetriol.

The aromatic dicarboxylic acid monomer constituent may be present in the copolyester in an amount of from about 10 mole % to about 40 mole %, in some embodiments from about 15 mole % to about 35 mole %, and in some embodiments, from about 15 mole % to about 30 mole %. The aliphatic dicarboxylic acid monomer constituent may likewise be present in the copolyester in an amount of from about 15 mole % to about 45 mole %, in some embodiments from about 20 mole % to about 40 mole %, and in some embodiments, from about 25 mole % to about 35 mole %. The polyol monomer constituent may also be present in the aliphatic-aromatic copolyester in an amount of from about 30 mole % to about 65 mole %, in some embodiments from about 40 mole % to about 50 mole %, and in some embodiments, from about 45 mole % to about 55 mole %.

As described above, in one aspect, the biodegradable polyester polymer comprises a polyhydroxyalkanoate alone or in combination with a polylactic acid. For instance, the polyhydroxyalkanoate can be a polyhydroxybutyrate. In one embodiment, a blend of different polyhydroxyalkanoates may be incorporated into the polymer composition.

Polylactic acid may generally be derived from monomer units of any isomer of lactic acid, such as levorotory-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the rate of content of one of the monomer unit derived from L-lactic acid and the monomer unit derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular embodiment, the polylactic acid has the following general structure:

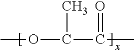

The biodegradable polyester typically has a melting point of from about 140° C. to about 260° C., in some embodiments from about 150° C. to about 250° C., and in some embodiments, from about 160° C. to about 220° C. Such biodegradable polyesters are useful in that they biodegrade at a fast rate. The glass transition temperature (“T_{g}”) of the polylactic acid may be relatively high, such as from about 40° C. to about 80° C., in some embodiments from about 50° C. to about 80° C., and in some embodiments, from about 55° C. to about 65° C. As discussed in more detail above, the melting temperature and glass transition temperature may be determined using differential scanning calorimetry (“DSC”) in accordance with ASTM D-3417.

The biodegradable polyester typically has a number average molecular weight (“Mₙ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number aver age molecular weights may be determined by methods known to those skilled in the art.

The biodegradable polyester may also have an apparent viscosity of from about 50 to about 600 Pascal seconds (Pa·s), in some embodiments from about 100 to about 500 Pa·s, and in some embodiments, from about 200 to about 400 Pa·s, as determined at a temperature of 190° C. and a shear rate of 1000 sec⁻¹. The melt flow rate of the biodegradable polyester (on a dry basis) may also range from about 0.1 to about 40 grams per 10 minutes, in some embodiments from about 0.5 to about 20 grams per 10 minutes, and in some embodiments, from about 5 to about 15 grams per 10 minutes, determined at a load of 2160 grams and at 190° C.

One or more biodegradable polymers, such as one or more biodegradable polyester polymers, can be contained in the polymer composition in an amount sufficient to form a continuous phase. For instance, one or more biodegradable polymers can be present in the polymer composition in an amount greater than about 40% by weight, such as in an amount greater than about 45% by weight, such as in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight. One or more biodegradable polymers can be present in the polymer composition generally in an amount less than about 99.9% by weight, such as less than about 98% by weight, such as less than about 95% by weight.

The polymer composition of the present disclosure also contains a polymeric strength enhancing agent. Due to its polymeric nature, the polymeric strength enhancing agent possesses a relatively high molecular weight that can help improve the melt strength and stability of the thermoplastic composition. The polymeric strength enhancing agent can be generally immiscible with the one or more biodegradable polymers. In this manner, the polymeric strength enhancing agent can become dispersed as discrete phase domains within a continuous phase of the one or more biodegradable polymers. The discrete domains are capable of absorbing energy that arises from stress imparted during elongation of the composition during drawing, which increases the overall toughness and strength of the resulting fiber or film. While the polymers are generally immiscible, the polymeric strength enhancing agent may nevertheless be selected to have a solubility parameter that is relatively similar to that of one or more biodegradable polymers. This generally improves the interfacial adhesion and physical interaction of the boundaries of the discrete and continuous phases, and thus reduces the likelihood that the composition will fracture upon stretching.

The polymeric strength enhancing agent can be selected to have a certain melt flow rate (or viscosity) to ensure that the discrete domains can be adequately maintained. In this regard, the ratio of the melt flow rate of the polymeric strength enhancing agent to the melt flow rate of the one or more biodegradable polymers can be from about 0.2 to about 8, in some embodiments from about 0.5 to about 6, and in some embodiments, from about 1 to about 5. The polymeric strength enhancing agent may, for example, have a melt flow rate of from about 0.1 to about 250 grams per 10 minutes, in some embodiments from about 0.5 to about 200 grams per 10 minutes, and in some embodiments, from about 5 to about 150 grams per 10 minutes, determined at a load of 2160 grams and at 190° C.

In addition to the properties noted above, the mechanical characteristics of the polymeric strength enhancing agent are also generally selected to achieve the desired increase in strength, including fiber toughness. For example, when a blend of the one or more biodegradable polymers and polymeric strength enhancing agent is stretched during fiber drawing, shear and/or plastic yielding zones may be initiated at and around the discrete phase domains as a result of stress concentrations that arise from a difference in the elastic modulus of the polymeric strength enhancing agent and one or more biodegradable polymers. Larger stress concentrations promote more intensive localized plastic low at the domains, which allows them to become significantly elongated during fiber drawing. These elongated domains allow the composition to exhibit a more pliable and softer behavior than the otherwise. To enhance the stress concentrations, the polymeric strength enhancing agent is selected to have a relatively low Young's modulus of elasticity in comparison to the one or more biodegradable polymers.

To impart the desired increase in strength, the polymeric strength enhancing agent may also exhibit a peak elongation (i.e., the percent elongation of the polymer at its peak load) greater than the biodegradable polyester polymer. For example, the polymeric strength enhancing agent of the present invention may exhibit a peak elongation of about 50% or more, in some embodiments about 100% or more, in some embodiments from about 100% to about 2000%, and in some embodiments, from about 250% to about 1500%.

While a wide variety of polymeric strength enhancing agents may be employed that have the properties identified above, particularly suitable examples of such polymers may include, for instance, polyolefins (e.g., polyethylene, polypropylene, polybutylene, etc.); polytetrafluoroethylenes; polyesters (e.g., recycled polyester, polyethylene terephthalate, etc.); polyvinyl acetates (e.g., poly(ethylene vinyl acetate), polyvinyl chloride acetate, etc.); polyvinyl alcohols (e.g., polyvinyl alcohol, poly(ethylene vinyl alcohol), etc.; polyvinyl butyrals; acrylic resins (e.g., polyacrylate, polymethylacrylate, polymethylmethacrylate, etc.); polyamides (e.g., nylon); polyvinyl chlorides; polyvinylidene chlorides; polystyrenes; polyurethanes; etc. Suitable polyolefins may, for instance, include ethylene polymers (e.g., low density polyethylene (‘LDPE’), high density polyethylene (‘HDPE’), linear low density polyethylene (‘LLDPE’), etc.), propylene homopolymers (e.g., syndiotactic, atactic, isotactic, etc.), propylene copolymers, and so forth.

In one particular embodiment, the polymer is a propylene polymer, such as homopolypropylene or a copolymer of propylene. The propylene polymer may, for instance, be formed a substantially isotactic polypropylene homopolymer or a copolymer containing equal to or less than about 10 wt. % of other monomer, i.e., at least about 90% by weight propylene. Such homopolymers may have a melting point of from about 160° C. to about 170° C.

In still another embodiment, the polyolefin may be a copolymer of ethylene or propylene with another α-olefin, such as a C₃-C₂₀ α-olefin or C₃-C₁₂ α-olefin. Specific examples of suitable α-olefins include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene or propylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %.

Exemplary olefin copolymers for use in the present invention include ethylene-based copolymers available under the designation EXACT™ from ExxonMobil Chemical Company of Houston, Tex. Other suitable ethylene copolymers are available under the designation ENGAGE™, AFFINITY™, DOWLEX™ (LLDPE) and ATTANE™ (ULDPE) from Dow Chemical Company of Midland, Mich. Other suitable ethylene polymers are described in U.S. Pat. No. 4,937,299 to Ewen et al.; U.S. Pat. No. 5,218,071 to Tsutsui et al.; U.S. Pat. No. 5,272,236 to Lai, et al.; and U.S. Pat. No. 5,278,272 to Lai, et al., which are incorporated herein in their entirety by reference thereto for al purposes. Suitable propylene copolymers are also commercially available under the designations VISTAMAXX™ from ExxonMobil Chemical Co. of Houston, Tex.; FINA™ (e.g., 8573) from Atofina Chemicals of Feluy, Belgium; TAFMER™ available from Mitsui Petrochemical Industries; and VERSIFY™ available from Dow Chemical Co. of Midland, Mich. Other examples of suitable propylene polymers are described in U.S. Pat. No. 6,500,563 to Datta, et al.; U.S. Pat. No. 5,539,056 to Yang, et al.; and U.S. Pat. No. 5,596,052 to Resconi, et al., which are incorporated herein in their entirety by reference thereto for all purposes.

Any of a variety of known techniques may generally be employed to form the olein copolymers. For instance, olefin polymers may be formed using a free radical or a coordination catalyst (e.g., Ziegler-Natta). Preferably, the olefin polymer is formed from a single-site coordination catalyst, such as a metallocene catalyst. Such a catalyst system produces ethylene copolymers in which the comonomer is randomly distributed within a molecular chain and uniformly distributed across the different molecular weight fractions. Metallocene-catalyzed polyolefins are described, for instance, in U.S. Pat. No. 5,571,619 to McAlpin et al.; U.S. Pat. No. 5,322,728 to Davis et al.; U.S. Pat. No. 5,472,775 to Obijeski et al.; U.S. Pat. No. 5,272,236 to Lai et al.; and U.S. Pat. No. 6,090,325 to Wheat, et al., which are incorporated herein in their entirety by reference thereto for all purposes. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-fiourenyl)zirconium dichloride, molybdocene dichloride, nickelocene, niobocene dichloride, ruthenocene, titanocene dichloride, zirconocene chloride hydride, zirconocene dichloride, and so forth. Polymers made using metallocene catalysts typically have a narrow molecular weight range. For instance, metallocene-catalyzed polymers may have polydispersity numbers (M_{w}/Mₙ) of below 4, controlled short chain branching distribution, and controlled isotacticity.

One or more polymeric strength enhancing agents can be present in the polymer composition generally in an amount from about 0.1% by weight to about 25% by weight, including all increments of 0.1% by weight therebetween. For many applications, however, only minor amounts of one or more polymeric strength enhancing agents need to be incorporated into the polymer composition for there to be significant improvements in mechanical properties, melt strength, or processing characteristics. For instance, one or more polymeric strength enhancing agents can be present in the polymer composition in an amount less than about 20% by weight, such as in an amount less than about 15% by weight, such as in an amount less than about 12% by weight, such as in an amount less than about 10% by weight, such as in an amount less than about 8% by weight, such as in an amount less than about 6% by weight, such as in an amount less than about 5% by weight, such as in an amount less than about 4% by weight, such as in an amount less than about 3% by weight, such as even in an amount less than about 2% by weight. One or more polymeric strength enhancing agents can be present in the polymer composition in an amount greater than about 0.25% by weight, such as in an amount greater than about 0.5% by weight, such as in an amount greater than about 0.75% by weight, such as in an amount greater than about 1% by weight.

In accordance with the present disclosure, the polymer composition further contains at least one prodegradant. The at least one prodegradant is selected such that it accelerates a degradation rate of the polymeric strength enhancing agent. Various different prodegradants can be incorporated into the polymer composition of the present disclosure. The prodegradant can be selected, for instance, based upon the polymeric strength enhancing agent incorporated into the composition and/or the amount of the polymeric strength enhancing agent present. In one aspect, the polymer composition contains at least two prodegradants, such as at least three prodegradants, such as at least four prodegradants.

In one aspect, the prodegradant can be a transition metal compound. For instance, the polymer composition can contain at least one transition metal compound, such as at least two transition metal compounds, such as at least three transition metal compounds, and generally less than about ten transition metal compounds.

The following description uses the term transition metal to refer to any of the metallic elements of groups IVB-VIII, IB, and IIB, or 4-12 in the periodic table. Preferred transition metals are iron, manganese, copper, cobalt and cerium, preferably where the iron is in the +3 oxidation state and where copper is in the +2 oxidation state. These compounds catalyze the degradation.

When two or more transition metal compounds are present, they can be selected from iron, manganese, copper, cobalt and cerium compounds and the transition metals in the two or more transition metal compounds are different. Preferably the two or more transition metal compounds are selected from ferric, manganese, copper, cobalt and cerium compounds and the transition metals in the two or more transition metal compounds are different. In one aspect, the transition metal in the two or more transition metal compounds comprise iron, manganese and copper; or manganese and copper; or iron and manganese.

The temperature of the polymer composition as well as its exposure to light may also effect its degradation rate. Iron is a more efficient photo catalyst whilst manganese is a more efficient thermal catalyst of the degradation process. The transition metal component may, therefore, be used to tune the degradation rate depending on the expected exposure to heat and light of a particular product.

The ligands of the metal compounds can be inorganic ligands and/or saturated organic ligands. Preferably the ligands of the metal compounds do not comprise mono- or poly-unsaturated C14-C24 carboxylic acid, or an ester, anhydride or amide thereof.

The transition metal compounds can comprise moieties selected from stearate, carboxylate, acetylacetonate, triazacyclononane or combinations of two or more thereof. In one aspect, the transition metal compounds include stearates and may be present at a weight ratio of iron stearate and manganese stearate to copper stearate from 4:1 to 8:1. For instance, the transition metal compounds may be present at a ratio of ferric stearate and manganese stearate to copper stearate of from 4:1 to 8:1.

One or more transition metal compounds can be present in the polymer composition in relatively small amounts, such as in amounts less than about 1% by weight. For instance, one or more transition metal compounds can be present in the polymer composition in an amount less than about 0.8% by weight, such as in an amount less than about 0.5% by weight, such as in an amount less than about 0.4% by weight, such as in an amount less than about 0.3% by weight. One or more transition metal compounds can be present in the polymer composition generally in an amount greater than about 0.08% by weight, such as in an amount greater than about 0.1% by weight, such as in an amount greater than about 0.12% by weight.

Instead of or in addition to one or more transition metal compounds, the polymer composition can also contain a ligand selected from amines, imines, amides, phosphites, phosphines, carbenes, and mixtures thereof. Such ligands are particularly well suited for use with transition metal compounds.

Another prodegradant that can be present in the polymer composition is a carboxylic acid, particularly an unsaturated carboxylic acid having a carbon chain length of from about 12 carbon atoms to about 26 carbon atoms. The prodegradant can also be an ester, an anhydride, or an amide of the carboxylic acid.

The following description uses the term carboxylic acid to refer to the range of molecules containing a carboxylic acid —(COOH) moiety. The carboxylic acid can be mono- or poly-unsaturated and has a carbon backbone containing between 14 and 24 carbon atoms, meaning it has at least one double in the carbon backbone. The carbon backbone of the carboxylic acid may be linear, branched or aromatic. Preferably the mono- or poly-unsaturated carboxylic acid is a C₁₆-C₂₀ carboxylic acid. Preferred carboxylic acids are oleic, linoleic and cinnamic, most preferably the carboxylic acid is oleic acid.

Alternatively, the degradable polymer composition comprises an ester, anhydride or amide of a mono- or poly-unsaturated C₁₄-C₂₄ carboxylic acid as described above.

The carboxylic acid or an ester, anhydride or amide thereof are preferably “free” or “non-coordinated”, in the sense that they do not form a part of a transition metal compound.

Where the degradable polymer composition comprises an ester of a mono- or poly-unsaturated C₁₄-C₂₄ carboxylic acid the alcohol component preferably comprises a C₁-C₃₀ alcohol, more preferably a saturated straight chain C₁-C₃₀ alcohol.

Where the degradable polymer composition comprises an anhydride of a mono- or poly-unsaturated C₁₄-C₂₄ carboxylic acid, the anhydride may or may not be symmetrical. The second carboxylic acid component preferably comprises a C₁-C₃₀ carboxylic acid, more preferably a saturated straight chain C₁-C₃₀ carboxylic acid.

Where the degradable polymer composition comprises an amide of a mono- or poly-unsaturated C₁₄-C₂₄ carboxylic acid, the amide may be a primary, secondary or tertiary amide. Where a secondary or tertiary amide is present, each of the carbon chains preferably comprises from 1 to 30 carbon atoms, more preferably each carbon chain is a C₁-C₃₀ alkyl group.

Unless otherwise specified, where features of the carboxylic acid are discussed in this description it is intended to also encompass the ester, anhydride or amide thereof.

Without wishing to be bound by theory, it is believed that the mono- or poly-unsaturated C₁₄-C₂₄ carboxylic acid in the polymer composition auto-oxidizes to yield peroxides which can attack the carbon-carbon linkages of the polymer chain, making the polymer susceptible to normal degradation processes. The presence of transition metals catalyze the auto-oxidation increasing the degradation rate of the polymer composition.

The carboxylic acid or an ester, anhydride or amide thereof can be present in the polymer composition generally in an amount less than about 0.5% by weight, such as in an amount less than about 0.2% by weight, such as in an amount less than about 0.16% by weight, such as in an amount less than about 0.14% by weight. The carboxylic acid or ester, anhydride, or amide thereof can be present generally in an amount greater than about 0.01% by weight, such as in an amount greater than about 0.05% by weight, such as in an amount greater than about 0.09% by weight, such as in an amount greater than about 0.11% by weight.

In still another embodiment, the prodegradant can comprise a sugar including starches. Examples of sugars that can be incorporated into the composition include but are not limited to: galactose, galactonate, succinate, malate, aspartate, serine, furnarate, ribose, pyruvate, oxalacetate and other L-sugar structures and D-sugar structures but not limited thereto. In a one embodiment the sugar is a non-esterified starch.

The starch, for instance, can be a dried starch. The starch, for instance, can be a polysaccharide comprised of glucose units joined by glycosidic bonds. A sugar including one or more starches can be present in the polymer composition in amounts anywhere from about 0.1% by weight to about 18% by weight, including all increments of 0.1 wt. % therebetween. For instance, a sugar or starch can be present in an amount greater than about 0.1% by weight, such as in an amount greater than about 0.5% by weight, such as in an amount greater than about 1% by weight, such as in an amount greater than about 1.5% by weight, and generally less than about 10% by weight, such as less than about 8% by weight, such as less than about 5% by weight. Sugars including starches are particularly well suited for use in combination with other prodegradants.

In another embodiment, the prodegradant can be a calcium salt. The calcium salt, for instance, can be calcium carbonate, calcium oxide, or mixtures thereof. The inclusion of a calcium salt can improve the processing characteristics of the polymer composition in addition to accelerating a degradation rate of the polymeric strength enhancing agent. One or more calcium salts can be present in the polymer composition generally in an amount less than about 3% by weight, such as in an amount less than about 2% by weight, such as in an amount less than about 1.5% by weight, and generally in an amount greater than about 0.1% by weight, such as in an amount greater than about 0.5% by weight.

In another aspect, the prodegradant can be one or more furanone compounds. Some furanones can serve as an attractant for bacteria. Suitable furanones may include but are not limited to: 3,5_dimethylyentenyl_dihydro_2(3H)furanone isomer mixtures, emoxyfurane, and N-acylhomoserine lactones Bacteria that have shown to attract to the furanone compounds listed above include, but are not limited to C. violaceum. One or more furanones can be present in the polymer composition in an amount less than about 3% by weight, such as in an amount less than about 1.5% by weight, such as in an amount less than about 0.5% by weight, such as in an amount less than about 0.2% by weight. One or more furanones can be present in the polymer composition generally in an amount greater than about 0.001% by weight, such as in an amount greater than about 0.01% by weight, such as in an amount greater than about 0.1% by weight.

Other prodegradants that may be incorporated into the composition include a furanone compound, a glutaric acid, a hexadecanoic acid compound, or mixtures thereof. The glutaric acid compound can be, for example, propylglutaric acid. Each of the above prodegradants can be present in the polymer composition in an amount less than about 4% by weight, such as in an amount less than about 2% by weight, such as in an amount less than about 1% by weight, such as in an amount less than about 0.5% by weight. Each of the above prodegradants can be present in the polymer composition generally in an amount greater than about 0.001% by weight, such as in an amount greater than about 0.01% by weight, such as in an amount greater than about 0.1% by weight.

In one embodiment, the polymer composition can include at least one, such as at least two, transition metal compounds in combination with at least one other prodegradant. The other prodegradant, for instance, can be the carboxylic acid, or an ester, anhydride, or amide thereof, alone or in combination with a starch and/or a calcium salt.

One beneficial aspect of the present disclosure is that good mechanical properties (e.g., elongation) may be provided without the need for conventional plasticizers, such as alkylene glycols. The thermoplastic composition of the present invention may thus be substantially free of such plasticizers. Nevertheless, it should be understood that plasticizers may be used in certain embodiments. When utilized, however, the plasticizers are typically present in an amount of less than about 10 wt. %, in some embodiments from about 0.1 wt. % to about 5 wt. %, and in some embodiments, from about 0.2 wt. % to about 2 wt. % of the thermoplastic composition.

Of course, other ingredients may be utilized for a variety of different reasons. For instance, materials that may be used include, without limitation, catalysts, pigments, antioxidants, stabilizers, surfactants, waxes, flow promoters, solid solvents, nucleating agents (e.g., titanium dioxide, calcium carbonate, etc.), particulates, and other materials added to enhance the processability of the thermoplastic composition. When utilized, it is normally desired that the amounts of these additional ingredients are minimized to ensure optimum compatibility and cost-effectiveness. Thus, for example, it is normally desired that such ingredients constitute less than about 10 wt. %, in some embodiments less than about 8 wt. %, and in some embodiments, less than about 5 wt. % of the thermoplastic composition.

In one embodiment, the polymer composition may contain a swelling agent including fillers. The filler, for instance, may comprise clay particles. The clay particles can have an average particle size of generally less than about 15 microns, such as less than about 10 microns, such as less than about 5 microns, and generally greater than about 0.001 microns. In one embodiment, the day particles can be nanoparticles having a particle size of less than about 1 micron, such as less than about 0.8 microns, such as less than about 0.6 microns. In general, any suitable day can be incorporated into the polymer composition. In one embodiment, the clay particles can comprise diatomaceous earth. The swelling agents may be selected from but is not limited to the group of natural fibers, cultured colloids, organoleptic compounds, cyclo-dextrin or mixtures thereof. A swelling agent or filler can be present in the polymer composition in an amount less than about 12% by weight, such as in an amount less than about 5% by weight, such as in an amount less than about 3% by weight, such as in an amount less than about 2% by weight. A swelling agent or filer can be present in the polymer composition generally in an amount greater than about 0.5% by weight, such as in an amount greater than about 1% by weight, such as in an amount greater than about 2% by weight.

In forming polymer articles from the polymer composition of the present disclosure, the one or more biodegradable polyester polymers, one or more polymeric strength enhancing agents, and one or more prodegradants are melt blended together. In one embodiment, the one or more prodegradants can be incorporated into the polymer composition in compounded form as a masterbatch. For instance, the one or more prodegradants can be combined with a carrier polymer to form a masterbatch that is then combined with the one or more biodegradable polyester polymers and the one or more polymeric strength enhancing agents. The carrier polymer, for instance, can comprise a biodegradable polyester polymer or a polymeric strength enhancing agent polymer. For instance, the carrier polymer can comprise a polyolefin, such as a polypropylene or a polyethylene. The one or more prodegradants can be present in the master batch in an amount less than about 20% by weight, such as in an amount less than about 10% by weight, such as in an amount less than about 3% by weight, and generally in an amount greater than about 0.1% by weight, such as in an amount greater than about 0.2% by weight.

All different types of molded articles can be made in accordance with the present disclosure. The polymer composition, however, is particularly well suited to forming fibers and films.

Fibers formed from the blended thermoplastic composition may generally have any desired configuration, including monocomponent and multicomponent (e.g., sheath-core configuration, side-by-side configuration, segmented pie configuration, island-in-the-sea configuration, and so forth). In some embodiments, the fibers may contain one or more additional polymers as a component (e.g., bicomponent) or constituent (e.g., biconstituent) to further enhance strength and other mechanical properties. For instance, the thermoplastic composition may form a sheath component of a sheath/core bicomponent fiber, while an additional polymer may form the core component, or vice versa. The additional polymer may be a thermoplastic polymer that is not generally considered biodegradable, such as polyolefins, e.g., polyethylene, polypropylene, polybutylene, and so forth; polytetrafluoroethylene; polyesters, e.g., polyethylene terephthalate, and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; and polyurethanes. More desirably, however, the additional polymer is biodegradable, such as aliphatic polyesters, such as polyesteramides, modified polyethylene terephthalate, polyglycolic acid, polyalkylene carbonates (such as polyethylene carbonate), polyhydroxyalkanoates (PHA), polyhydroxybutyrates (PHB), polyhydroxyvalerates (PHV), polyhydroxybutyrate-hydroxyvalerate copolymers (PHBV), and polycaprolactone, and succinate-based aliphatic polymers (e.g., polybutylene succinate, polybutylene succinate adipate, and polyethylene succinate); aromatic polyesters; or other aliphatic-aromatic copolyesters.

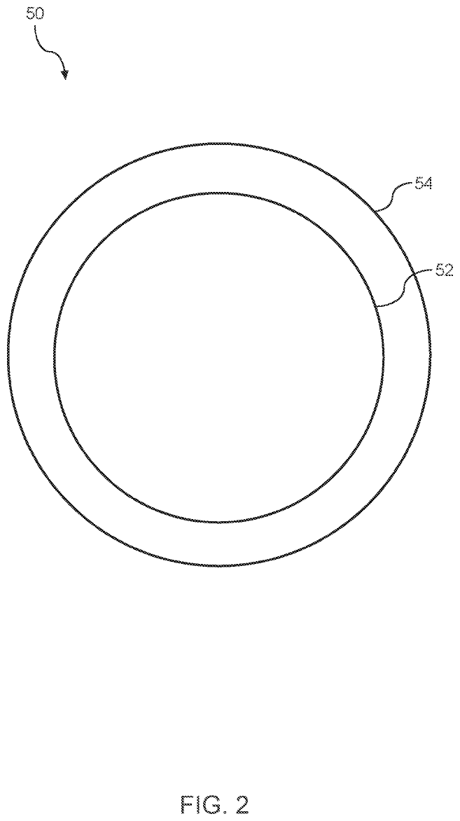

Referring to FIG. 2, for instance, a cross-sectional view of a bicomponent fiber 50 is shown. The bicomponent fiber 50 includes a core 52 surrounded by a sheath 54. In one embodiment, the core 52 can be formed from the polymer composition of the present disclosure. The sheath 54, on the other hand, can be made entirely from one or more biodegradable polymers, particularly one or more biodegradable polyester polymers, such as PHA.

Any of a variety of processes may be used to form fibers in accordance with the present invention. For example, the thermoplastic composition described above may be extruded through a spinneret, quenched, and drawn into the vertical passage of a fiber draw unit. Once formed, the fibers may then be cut to form staple fibers having an average fiber length in the range of from about 3 to about 80 millimeters, in some embodiments from about 4 to about 65 millimeters, and in some embodiments, from about 5 to about 50 millimeters. The staple fibers may then be incorporated into a nonwoven web as is known in the art, such as bonded carded webs, through-air bonded webs, etc. The fibers may also be deposited onto a foraminous surface to form a nonwoven web.

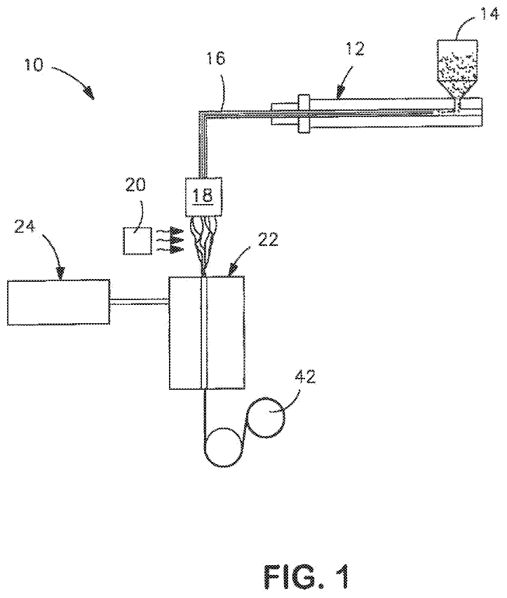

Referring to FIG. 1, for example, one embodiment of a method for forming fibers, such as spunbond fibers, is shown in more detail. In this particular embodiment, the polymer blend is fed into an extruder 12 from a hopper 14. The blend may be provided to the hopper 14 using any conventional technique.

The extruder 12 is heated to a temperature sufficient to extrude the melted polymer. The extruded composition is then passed through a polymer conduit 16 to a spinneret 18. For example, the spinneret 18 may include a housing containing a spin pack having a plurality of plates stacked one on top of each other and having a pattern of openings arranged to create flow paths for directing polymer components. The spinneret 18 also has openings arranged in one or more rows. The openings form a downwardly extruding curtain of filaments when the polymers are extruded therethrough. The process 10 also employs a quench blower 20 positioned adjacent the curtain of fibers extending from the spinneret 18. Air from the quench air blower 20 quenches the fibers extending from the spinneret 18. The quench air may be directed from one side of the fiber curtain as shown in FIG. 1 or both sides of the fiber curtain.

After quenching, the fibers are drawn into the vertical passage of a fiber draw unit 22. Fiber draw units or aspirators for use in melt spinning polymers are well-known in the art. Suitable fiber draw units for use in the process of the present invention include a linear fiber aspirator of the type shown in U.S. Pat. Nos. 3,802,817 and 3,423,255, which are incorporated herein in their entirety by reference thereto for all relevant purposes. The fiber draw unit 22 generally includes an elongated vertical passage through which the fibers are drawn by aspirating air entering from the sides of the passage and flowing downwardly through the passage. A heater or blower 24 supplies aspirating air to the fiber draw unit 22. The aspirating air draws the fibers and ambient air through the fiber draw unit 22. The flow of gas causes the fibers to draw or attenuate which increases the molecular orientation or crystallinity of the polymers forming the fibers. The fibers are deposited through the outlet opening of the fiber draw unit 22 and onto a godet roll 42.

Due to the increased strength of the fibers of the present invention, high draw ratios may be employed in the present invention without resulting in fracture. The draw ratio is the linear speed of the fibers after drawing (e.g., linear speed of the godet roll 42 or a foraminous surface (not shown) divided by the linear speed of the fibers after extrusion. For example, the draw ratio may be calculated in certain embodiments as follows:

$$\\ Draw Ratio = A / B$$

wherein,
A is the linear speed of the fiber after drawing (i.e., godet speed) and is directly measured; and
B is the linear speed of the extruded fiber and can be calculated as follows:

$$\\ Extruder linear fiber speed = C / ( 25 * π * D * {E}^{2} )$$

wherein,
C is the throughput through a single hole (grams per minute);
D is the melt density of the polymer (grams per cubic centimeter); and
E is the diameter of the orifice (in centimeters) through which the fiber is extruded. In certain embodiments of the present invention, the draw ratio may be from about 200:1 to about 8500:1, in some embodiments from about 500:1 to about 7500:1, and in some embodiments, from about 1000:1 to about 6000:1. If desired, the fibers collected on the godet roll 42 may optionally be subjected to additional in line processing and/or converting steps (not shown) as will be understood by those skilled in the art. For example, staple fibers may be formed by “cold drawing” the collected fibers at a temperature below their softening temperature to the desired diameter, and thereafter crimping, texturizing, and/or and cutting the fibers to the desired fiber length.

The fibers of the present invention may also be formed into a coherent web structure by randomly depositing the fibers onto a forming surface (optionally with the aid of a vacuum) and then bonding the resulting web using any known technique. For example, an endless foraminous forming surface may be positioned below the fiber draw unit and receive the fibers from an outlet opening. A vacuum may be positioned below the forming surface to draw the fibers and consolidate the unbonded nonwoven web. Once formed, the nonwoven web may then be bonded using any conventional technique, such as with an adhesive or autogenously (e.g., fusion and/or self-adhesion of the fibers without an applied external adhesive). Autogenous bonding, for instance, may be achieved through contact of the fibers while they are semi-molten or tacky. Suitable autogenous bonding techniques may include ultrasonic bonding, thermal bonding, through-air bonding, calendar bonding, and so forth. For example, the web may be further bonded or embossed with a pattern by a thermo-mechanical process in which the web is passed between a heated smooth anvil roll and a heated pattern roll. The pattern roll may have any raised pattern which provides the desired web properties or appearance. Desirably, the pattern roll defines a raised pattern which defines a plurality of bond locations which define a bond area between about 2% and 30% of the total area of the roll. Exemplary bond patterns include, for instance, those described in U.S. Pat. No. 3,855,046 to Hansen et al., U.S. Pat. No. 5,620,779 to Levy et al., U.S. Pat. No. 5,962,112 to Haynes et al., U.S. Pat. No. 6,093,665 to Sayovitz et al., as well as U.S. Design Pat. No. 428,267 to Romano et al.; U.S. Pat. No. 390,708 to Brown; U.S. Pat. No. 418,305 to Zander, et al.; U.S. Pat. No. 384,508 to Zander, et al.; U.S. Pat. No. 384,819 to Zander, et al.; U.S. Pat. No. 358,035 to Zander, et al.; and U.S. Pat. No. 315,990 to Blenke, et al., all of which are incorporated herein in their entirety by reference thereto for all purposes.

In addition to spunbond webs, a variety of other nonwoven webs may also be formed from the thermoplastic composition in accordance with the present invention, such as meltblown webs, bonded carded webs, wet-laid webs, airlaid webs, coform webs, hydraulically entangled webs, etc. For example, the thermoplastic composition may be extruded through a plurality of fine die capillaries into a converging high velocity gas (e.g., air) streams that attenuate the fibers to reduce their diameter. Thereafter, the meltblown fibers are carried by the high velocity gas stream and are deposited on a collecting surface to form a web of randomly dispersed meltblown fibers. Alternatively, the polymer may be formed into a carded web by placing bales of fibers formed from the thermoplastic composition into a picker that separates the fibers. Next, the fibers are sent through a combing or carding unit that further breaks apart and aligns the fibers in the machine direction so as to form a machine direction-oriented fibrous nonwoven web. Once formed, the nonwoven web is typically stabilized by one or more known bonding techniques.

Nonwoven laminates may also be formed in which one or more layers are formed from the thermoplastic composition. For example, the nonwoven web of one layer may be a spunbond that contains the thermoplastic composition, while the nonwoven web of another layer contains thermoplastic composition, other biodegradable polymer(s), and/or any other polymer (e.g., polyolefins). In one embodiment, the nonwoven laminate contains a meltblown layer positioned between two spunbond layers to form a spunbond/meltblown/spunbond (“SMS”) laminate. If desired, the spunbond layer(s) may be formed from the thermoplastic composition. The meltblown layer may be formed from the thermoplastic composition, other biodegradable polymer(s), and/or any other polymer (e.g., polyolefins). Various techniques for forming SMS laminates are described in U.S. Pat. No. 4,041,203 to Brock et al.; U.S. Pat. No. 5,213,881 to Timmons, et al.; U.S. Pat. No. 5,464,688 to Timmons, et al.; U.S. Pat. No. 4,374,888 to Bornslaeger; U.S. Pat. No. 5,169,706 to Collier, et al.; and U.S. Pat. No. 4,766,029 to Brock et al., as well as U.S. Patent Application Publication No. 2004/0002273 to Fitting, et al., all of which are incorporated herein in their entirety by reference thereto for all purposes. Of course, the nonwoven laminate may have other configuration and possess any desired number of meltblown and spunbond layers, such as spunbond/meltblown/meltblown/spunbond laminates (“SMMS”), spunbond/meltblown laminates (“SM”), etc. Although the basis weight of the nonwoven laminate may be tailored to the desired application, it generally ranges from about 10 to about 300 grams per square meter (“gsm”), in some embodiments from about 25 to about 200 gsm, and in some embodiments, from about 40 to about 150 gsm.

If desired, the nonwoven web or laminate may be applied with various treatments to impart desirable characteristics. For example, the web may be treated with liquid-repellency additives, antistatic agents, surfactants, colorants, antifogging agents, fluorochemical blood or alcohol repellents, lubricants, and/or antimicrobial agents. In addition, the web may be subjected to an electret treatment that imparts an electrostatic charge to improve filtration efficiency. The charge may include layers of positive or negative charges trapped at or near the surface of the polymer, or charge clouds stored in the bulk of the polymer. The charge may also include polarization charges that are frozen in alignment of the dipoles of the molecules. Techniques for subjecting a fabric to an electret treatment are well known by those skilled in the art. Examples of such techniques include, but are not limited to, thermal, liquid-contact, electron beam and corona discharge techniques. In one particular embodiment, the electret treatment is a corona discharge technique, which involves subjecting the laminate to a pair of electrical fields that have opposite polarities. Other methods for forming an electret material are described in U.S. Pat. No. 4,215,682 to Kubik, et al.; U.S. Pat. No. 4,375,718 to Wadsworth; U.S. Pat. No. 4,592,815 to Nakao; U.S. Pat. No. 4,874,659 to Ando; U.S. Pat. No. 5,401,446 to Tsai, et al.; U.S. Pat. No. 5,883,026 to Reader, et al.; U.S. Pat. No. 5,908,598 to Rousseau, et al.; U.S. Pat. No. 6,365,088 to Knight, et al., which are incorporated herein in their entirety by reference thereto for all purposes.

The nonwoven web may be used in a wide variety of applications. For example, the nonwoven web may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipe, and so forth; medical absorbent articles, such as garments, fenestration materials, underpads, bedpads, bandages, absorbent drapes, and medical wipes; food service wipers; clothing articles; pouches, and so forth. Materials and processes suitable for forming such articles are well known to those skilled in the art. Absorbent articles, for instance, typically include a substantially liquid-impermeable layer (e.g., outer cover), a liquid-permeable layer (e.g., bodyside liner, surge layer, etc.), and an absorbent core. In one embodiment, for example, a nonwoven web formed according to the present invention may be used to form an outer cover of an absorbent article. If desired, the nonwoven web may be laminated to a liquid-impermeable film that is either vapor-permeable or vapor-impermeable.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymer composition comprising:
a biodegradable polyester polymer present in the polymer composition in an amount greater than about 40% by weight;
a polymeric strength enhancing agent comprising a polyolefin, a polyalkylene terephthalate, or mixtures thereof; and
at least one prodegradant that accelerates a degradation rate of the polymeric strength enhancing agent, wherein the at least one prodegradant comprises an unsaturated carboxylic acid having a carbon chain length of from 12 carbon atoms to 26 carbon atoms, or an ester, anhydride or amide thereof.

2. The polymer composition as defined in claim 1, wherein the at least one prodegradant comprises a transition metal compound.

3. The polymer composition as defined in claim 2, wherein the transition metal compound comprises an iron, manganese or copper salt of a carboxylic acid.

4. The polymer composition as defined in claim 3, wherein the transition metal compound comprises an iron stearate, a manganese stearate, a copper stearate, or mixtures thereof.

5. The polymer composition as defined in claim 1, wherein the at least one prodegradant comprises two or more transition metal compounds in a total amount of from about 0.08% to about 0.5% by weight.

6. (canceled)

7. The polymer composition as defined in claim 1, wherein the unsaturated carboxylic acid having a carbon chain length of from about 12 carbon atoms to about 26 carbon atoms, or an ester, anhydride or amide thereof is present in the polymer composition in an amount of from about 0.01% to about 0.2% by weight.

8. The polymer composition as defined in claim 1, wherein the at least one prodegradant comprises a sugar, a calcium oxide, a calcium carbonate, a furanone compound, a glutaric acid, a hexadecenoic acid compound, or mixtures thereof.

9. (canceled)

10. (canceled)

11. The polymer composition as defined in claim 1, wherein the polymeric strength enhancing agent comprises a polyolefin.

12. The polymer composition as defined in claim 11, wherein the polyolefin is a propylene homopolymer, a propylene/α-olefin copolymer, an ethylene/α-olefin copolymer, or a combination thereof.

13. The polymer composition as defined in claim 11, wherein the polyolefin is an ethylene homopolymer, an ethylene copolymer, or a combination thereof.

14. The polymer composition as defined in claim 1, wherein the polymeric strength enhancing agent comprises a polyalkylene terephthalate, the polyalkylene terephthalate comprising a polyethylene terephthalate.

15. The polymer composition as defined in claim 1, wherein the polymeric strength enhancing agent comprises from about 0.25 wt. % to about 25 wt. % of the polymer composition.

16. The polymer composition as defined in claim 1, wherein the biodegradable polyester polymer comprises a polyhydroxyalkanoate.

17. The polymer composition as defined in claim 16, wherein the biodegradable polyester polymer comprises a polyhydroxybutyrate.

18. The polymer composition as defined in claim 1, wherein the biodegradable polyester polymer comprises a polylactic acid.

19. The polymer composition as defined in claim 1, wherein the polymer composition further comprises a filler.

20. The polymer composition as defined in claim 19, wherein the filler comprises clay particles.

21. (canceled)

22. A fiber formed from the polymer composition as defined in claim 1.

23. The fiber as defined in claim 22, wherein the fiber comprises a meltblown fiber or a spunbond fiber.

24. The fiber as defined in claim 22, wherein the fiber is a bicomponent fiber including a sheath polymer surrounding a core polymer.

25. The fiber as defined in claim 24, wherein the sheath polymer comprises a biodegradable polyester polymer, the core polymer comprising the polymer composition as defined in claim 1.

26. A nonwoven web comprising a plurality of fibers as defined in claim 22.
